(19) United States
(12) Patent Application Publication
(10) Pub. No.: US 2013/0166419 A1
(43) Pub. Date: Jun. 27, 2013

(54) SYSTEM AND METHOD FOR ADDING ARTICLES OF COMMERCE TO VIRTUAL REALITY ENVIRONMENTS

(71) Applicant: Leigh M. Rothschild, Sunny Isles Beach, FL (US)

(72) Inventor: Leigh M. Rothschild, Sunny Isles Beach, FL (US)

(73) Assignee: REAGAN INVENTIONS, LLC, Sunny Isles Beach, FL (US)

(21) Appl. No.: 13/337,350

(22) Filed: Dec. 27, 2011

(51) Int. Cl. G06F 3/01; G06Q 30/06

(52) U.S. Cl. 705/27.1; 715/738

(57) ABSTRACT

A system and method are provided for identifying an article of commerce, e.g., digital media content, downloading all or part of content related to the article of commerce to mobile devices such as portable digital media players and/or mobile phone devices and/or adding the article of commerce to a virtual environment. The present disclosure provides for identifying a specific object in the real world; obtaining an identification of the specific object using a mobile device; transmitting the identification of the specific object from the mobile device to a server on a network; determining, by the server, a list of available content related to the specific object and transmitting the list to the mobile device; selecting at least one available content from the list of available content and adding the selected content to a virtual environment.

### BACKGROUND

1. Field

The present disclosure relates generally to digital media content systems, and more particularly, to devices, systems and methods for identifying an article of commerce or object and downloading content related to the article of commerce or object and adding the article of commerce and/or related content to a virtual environment.

2. Description of the Related Art

Portable digital devices are now common. Examples include the various Windows™ Pocket PC devices which have an operating system created by Microsoft Corporation of Redmond, Wash. Another popular exemplary mobile device is the iPod™ and iPad™ series of mobile devices and tablets commercially available from Apple Computers, Inc. of Cupertino, Calif. Other devices include various mobile phone devices including many that have built-in camera imaging devices, such as the iPhone from Apple Computers, Inc and various types of “droid” phones which operate on the Android operating system developed by Google, Inc. of Mountain View, Calif. Still other portable digital devices include portable media players from Creative Media of Singapore, Samsung of South Korea, Archos, Inc. of Irvine, Calif., among others. Additionally, Sony of New York and Japan manufacture a portable game playing device called the Sony PSP™ (PlayStation Portable).

Increasingly, many of these portable media devices include a means of transmitting and receiving digital content and accessing various networks, such as the Internet. Various communications technologies are frequently built into these devices. Examples of portable communicating devices include mobile phones which employ GSM, CDMA, W-CDMA, and FOMA technology, among other standards, to send and receive data in addition to handling voice communications. Many of the portable media devices also include transmission capabilities including WiFi (IEEE 802.11a, b, g and x among others), Bluetooth, infrared, etc. to allow the user to transmit and receive digital content. The Sony PSP™ device, by example, includes WiFi (i.e., IEEE 802.11b) to transmit and receive digital data.

Virtual worlds and the avatars that interact within them are becoming popular on desktop and laptop computers. Virtual worlds are a genre of online community that often take the form of a computer-based simulated environment, through which users can interact with one another and use and create objects. Virtual worlds are intended for their users to inhabit and interact and have become synonymous with interactive 3D virtual environments, where the users take the form of avatars visible to others graphically. These avatars are usually depicted as textual, two-dimensional, or three-dimensional graphical representations, although other forms are possible. Most virtual worlds allow for multiple users.

Participants control the expressions and movements of their avatars by using a standard computer keyboard and mouse. A stereo headset and microphone provide audio interaction with the other participants. The software supporting the virtual world uses spatial audio effects in the stereo headset to give each participant a feeling of locality within the virtual space. The audio effects also allow each participant to place the other avatars spatially within the virtual world so that each participant can identify which avatar is speaking. The microphone captures the participant's speech which is then provided to other participants in the virtual world in a manner similar to a voice bridge, usually after spatial-audio processing as mentioned above.

One such virtual world is “Second Life”. Second Life is a virtual world developed by Linden Lab of San Francisco, Calif. and is accessible via the Internet. Second Life enables its users, called Residents, to interact with each other through avatars. Residents can explore, meet other residents, socialize, participate in individual and group activities, and create and trade virtual property and services with one another, or travel throughout the world (referred to as “the grid”). In this virtual world, users virtually navigate around the world and have the ability to find and purchase virtual goods that can be added to their avatar's inventory. Examples of items that can be bought are clothes to dress the avatar, furnishings for the avatar's virtual home or business, and cars. Virtual money, such as Linden Dollars, is used to buy the virtual goods. No actual or tangible thing is physically delivered. However, if a user has not earned and banked enough virtual money in the virtual world, the user can buy in using real money.

As virtual worlds become more popular, users will want to access them even when away from their standard computers. Mobile devices (e.g., smart telephones) are appearing that contain graphics processing units powerful enough to present a virtual world on the mobile device's display screen.

### SUMMARY

A system and method are provided for identifying an article of commerce, e.g., digital media content, and downloading all or part of content related to the article of commerce to mobile devices such as portable digital media players and/or mobile phone devices. The present disclosure will enable a user to find an existing digital entertainment product of interest such as but not limited to a music CD, music DVD, electronic game, text (such as a book,) or a movie/television DVD, clothing item, household item or retail item, to identify that product and then to transfer full or selected content, or associated content, to a mobile device, e.g., a portable digital media player and/or a mobile phone device. The system and method of the present disclosure may provide on the spot delivery of the exact content identified by the user, or a portion thereof, on the user's portable digital device(s) or may enable the user to upload a likeness of the selected content to a virtual environment.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1A is front view of a device for playing media content according to an embodiment of the present disclosure;

FIG. 1B is a rear view of a device for playing media content;

FIG. 2 is a block diagram of various modules included in the device illustrated in FIG. 1;

FIG. 3 illustrates a system for delivering media content to a user;

FIG. 4 is a flow diagram illustrating a method for delivering media content to a user according to an embodiment of the present disclosure; and

FIG. 5 is a flow diagram illustrating a method for uploading the likeness of an object to a virtual environment according to an embodiment of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A device, system and method for delivering media content to a user are provided. The system and method allow a user to identify digital content at a location for this content (such as a retail store) and to immediately download this content into the user's portable media device or cellular/mobile phone. This will provide the user with not only instant delivery, but a seamless way of obtaining the content (as opposed to manually loading the content), and in many cases a better economic model to obtain the content. The system and method will enable the user to compare the price of the content at the source (e.g., a retail store) and to instantly receive the content from an Internet source or sources. Further, the user may custom select the content that he desires and, instead of obtaining all content, the user may decide to purchase less of the content (e.g., a content subset) therefore customizing his selection, and reducing his/her price for the content.

In operation of the system and method of the present disclosure, a user locates an article of commerce such as a book, video or audio DVD, audio CD, electronic game, clothing item, retail item or household item, etc. The user utilizes a portable digital device, e.g., a mobile phone, to identify the article of commerce. Several technology solutions are provided to allow the article to be identified by a user, e.g., a device containing a CCD device (e.g., a camera) where the user will take a picture of a barcode on the article of commerce or scan the barcode; a device containing a user interface allowing user keyboard input where the user will input the name of the item into the portable device; the user may speak the name of the article of commerce into the portable device where the device contains voice recognition software, etc. In a further embodiment, the articles of commerce will contain Radio Frequency Identification (RFID) tags wherein these tags identify the article of commerce to a reader device. Furthermore, if the device contains a CCD device (e.g., a camera), the user can also take a picture of the article of commerce and using standard and existing computer processing power and software solutions such as image recognition software, or optical character recognition software, the image or name of the article of commerce is decoded and the identity of the article of commerce is resolved.

Once the article of commerce is identified, the portable device will use communications protocols including but not limited to WiFi (a, b, c d, n, x), cellular communications such as GSM, CDMA, FOMA, etc., infrared communications, cabled communications, Bluetooth communications, satellite communications, etc., to transmit this identification information to a remote server on the global computer network (GCN), e.g., the Internet. The user will also transmit information identifying the user submitting the request. The server will then use standard computer processing power and standard data look up software to see if it has information, e.g., content, on the article of commerce. The server will use standard communications protocols to transmit information back to the portable digital device. The user will now be informed (by the server) what content or parts of content for the selected article of commerce is available for download. The user will also be informed of the price of this download, and the user will be informed where the download will be sent to.

If the user wants to purchase this download, the user will now use the user interface that is built into his portable digital device including but not limited to character input, voice input, etc. to select the desired content. This information will then be transmitted to the server. The server will use standard computer processing power and e-commerce software to commence a transaction. Once (and if) the transaction is approved, the server will transmit the digital content to the address that the user has provided, e.g., the device used to conduct the transaction or another digital device such as a user's local computer. Alternatively, the user will select the desired content to preview the content at no cost to the user. The preview view of the content may be a portion of the selected content or the complete selection. If a portion is transmitted to the device, the user may purchase the complete selection after previewing the portion. Furthermore, the complete selection may be transferred to the user where only a portion is available for preview and the remainder of the selection is available after purchase, e.g., by the server providing a key after purchase. In another embodiment of this disclosure, the server may not have stored the digital content, but it may cause another site on the global computer network where the subject digital content is stored, to transmit the content to the user at the address provided.

Therefore, the present disclosure provides systems and methods for enabling a user to identify media content, transmit a request to a server related to the media content, select digital content related to the media content, and conduct a transaction to obtain the selected media content. In addition to these features, the present disclosure also provides further opportunities for the user. According to some embodiments, the user may identify various articles of commerce and retrieve information about the articles of commerce. But then, instead of purchasing the content related to the articles, the user is able to add the articles of commerce into a virtual environment. For example, the virtual environment may include a virtual world that can be accessed by a single user or one that can be accessed by multiple users over a network. Exemplary virtual worlds may include but are not limited to Second Life, SmallWorlds, Onverse, Active Worlds, Twinity, and Kaneva.

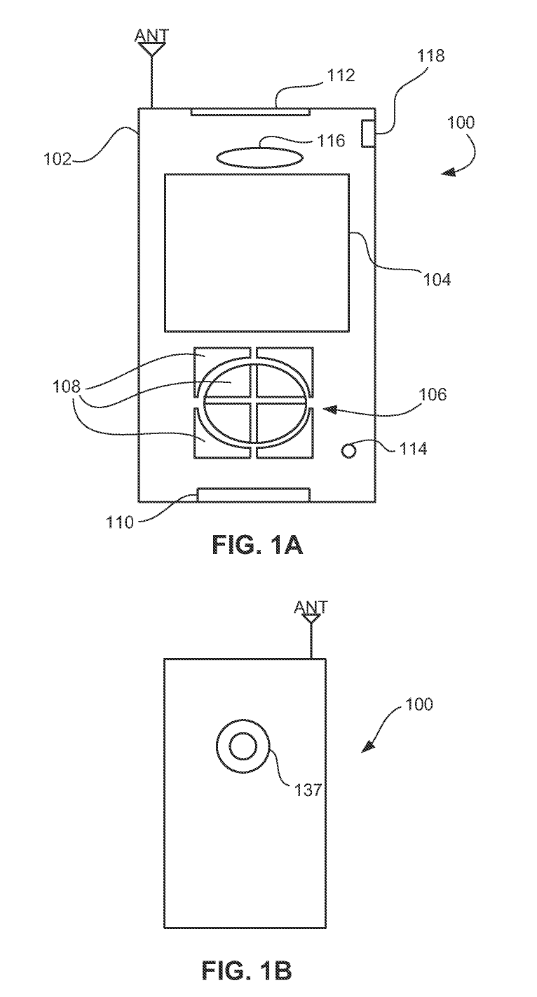

Referring to FIG. 1A, a portable media playback device 100 for receiving and playing various types of digital media content, e.g., audio, video, images, games, text, multimedia content, etc., in accordance with an embodiment of the present disclosure is illustrated. The media device 100 includes various electrical components, which will be described in detail below, disposed in a generally rectangular housing 102. A display module 104 is provided for displaying video and image media content, such as movies, animations, etc. and a speaker 116 is provided configured to produce audio, e.g., music or a soundtrack associated with a video. An audio port 118 will be configured to receive a plug or connector from a headphone, stereo system, etc. to stream the audio to the connected device. It is to be appreciated that when an external device is connected to the audio port 118 the speaker 116 will be disabled. Input module 106 includes a plurality of buttons 108 for inputting data and navigating through a plurality of menus. A touch screen overlaid upon the display module 104 may also be coupled to the input module for facilitating user input. The media device 100 further includes a storage module 110 for storing a plurality of content and a transmission module 112 for transmitting/receiving data and/or content to another device, e.g., a personal computer, a personal digital assistant (PDA), a server residing on the Internet, etc. Optionally, the media device 100 may include a microphone 114 for acquiring audio from the user of the device to input data.

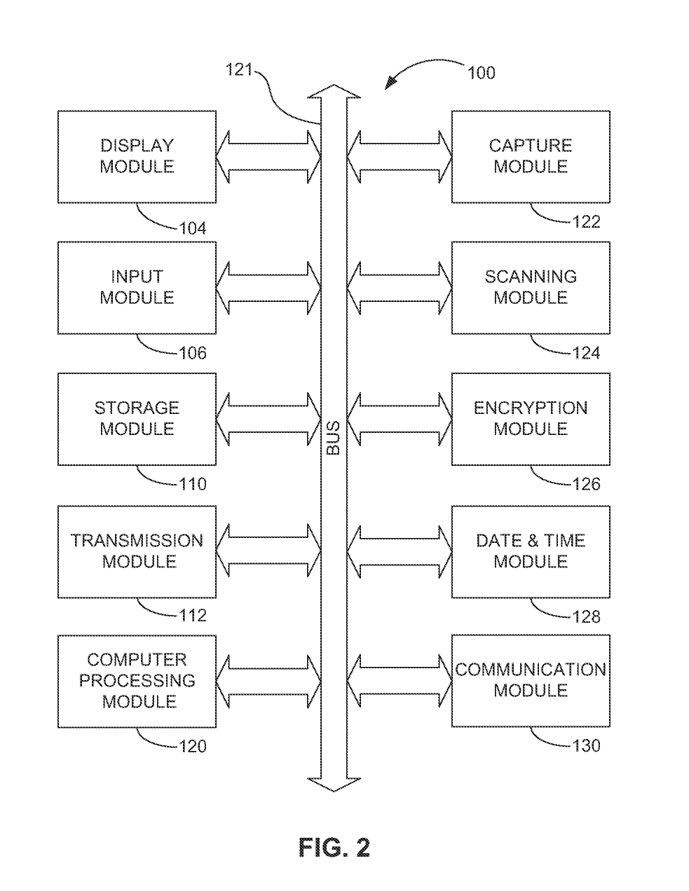

Referring to FIG. 2, the various components of the device 100 will now be described. The device will contain a computer processing module 120, e.g., a microprocessor. The computer processing module 120 will use computer software instructions that have been programmed into the module and conventional computer processing power to interact and organize the traffic flow between the various other modules. It is to be understood that the present disclosure may be implemented in various forms of hardware, software, firmware, special purpose processors, or a combination thereof. A system bus 121 couples the various components shown in FIG. 2 and may be any of several types of bus structures including a memory bus or memory controller, a peripheral bus, and a local bus using any of a variety of bus architectures. The device also includes an operating system and micro instruction code preferably residing in read only memory (ROM) (not shown). The various processes and functions described herein may either be part of the micro instruction code or part of an application program (or a combination thereof) which is executed via the operating system. Exemplary operating systems include but are not limited to SymbianOS, Windows Mobile/Windows CE, Palm OS, Linux, Blackberry OS, BREW, etc. which have been developed for mobile computing applications and can handle both data computing and communication applications, e.g., voice communications.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The computer processing module 120 may further include, in addition to a microprocessor, a digital signal processor (DSP) for decoding stored audio, video and photo files to be played on the media device 100. As is known in the art, the DSP may include several known decompression algorithms for decompressing stored media content, e.g., a MP3 file. The device 100 of the present disclosure will support various file types including but not limited to Microsoft Windows Media Video files (.wmv), Microsoft Photo Story files (.asf), Microsoft Windows Media Audio files (.wma), MP3 audio files (.mp3), JPEG image files (.jpg, .jpeg, .jpe, .jfif), MPEG movie files (.mpeg, .mpg, .mpe, .m1v, .mp2v .mpeg2), Microsoft Recorded TV Show files (.dvr-ms), Microsoft Windows Video files (.avi) and Microsoft Windows Audio files (.wav).

The device 100 will also contain a display module 104 for displaying digital information such as video files, image files, text files, etc. This display may be in any current form in the art, including Liquid Crystal Displays (LCD), Light emitting diode displays (LED), Cathode Ray Tube Displays (CRT) or any other type of display currently existing or existing in the future. The display module 104 may also include an audio output device, e.g., a speaker 116, audio port 118, etc., allowing the user to also hear audio output from the device 100, e.g., audio associated with a video, a MP3 file, etc.

The device 100 of the present disclosure will contain a user input module 106 to either receive user instructions via text input by the way of buttons 108, a standard keyboard interface coupled to the device, or a character recognition capture device which translates user text input into alphanumeric characters. Preferably, the character recognition device is a touch screen which overlays the display module 104 and text is entered via a pen-like stylus. Such input devices are standard and currently available on many electronic devices including portable digital assistants (PDAs) and cellular telephones. Optionally, microphone 114 may be further coupled to the input module 106 for capturing any audio information spoken by the user and the input module will further include an analog-to-digital (A/D) converter for converting the spoken audio information into a digital format. Furthermore, the input module may include a voice recognition processor that translates the digital human voice into alpha numeric characters for user input. The user will utilize the user input module 106 to enter various data, for example, to enter payment information, to initiate communication with a remote server, to flag desired content to be downloaded, to request an initial selection of media content to be downloaded, etc.

The storage module 110 includes internal storage memory, e.g., random access memory (RAM), or removable memory such as magnetic storage memory; optical storage memory, e.g., the various known types of CD and DVD media; solid-state storage memory, e.g., a CompactFlash card, a Memory Stick, SmartMedia card, MultiMediaCard (MMC), SD (Secure Digital) memory; or any other memory storage that exists currently or will exist in the future.

The transmission module 112 will enable the device 100 to transmit or transfer information to other computing devices and to receive information from other computing devices, e.g., digital media files, codes to unlock downloaded media, encryption/decryption keys, etc. The transmission module 112 will perform its functionality by hardwired and/or wireless connectivity. The hardwire connection may include but is not limited to hard wire cabling e.g., parallel or serial cables, USB cable, Firewire (1394 connectivity) cables, and the appropriate port. The wireless connection will operate under any of the various known wireless protocols including but not limited to Bluetooth™ interconnectivity, infrared connectivity, radio transmission connectivity including computer digital signal broadcasting and reception commonly referred to as Wi-Fi or 802.11.X (where x denotes the type of transmission), satellite transmission or any other type of communication protocols or systems currently existing or to be developed for wirelessly transmitting data. The transmission module will compress and encode the encrypted information for transmission using any known wireless communication technology. In one embodiment, antenna ANT is coupled to the transmission module 112 for extending the wireless transmission range of the device 100.

A capture module 122 is provided to capture an image desired by the user in digital form, e.g., an image of an article of commerce, a barcode, etc. The capture module 122 includes an image sensor, an analog-to-digital (A/D) converter and a digital signal processor (DSP). Referring to FIG. 1B when a user desires to capture an image, a lens 137 disposed on a rear side of the device is aimed at a subject of the image and is used in conjunction with display module 104 for positioning a subject of the image in lieu of a viewfinder. Light is allowed to enter through the lens 137 and shine on the image sensor, e.g., a charge-coupled device (CCD) or complimentary metal-oxide semiconductor (CMOS). The image sensor includes preferably millions of photosensors, e.g., pixels, wherein each pixel absorbs the light and transforms the light into an electric charge proportional to the intensity of light. Each charge is transmitted to an A/D converter where the charge is converted into a digital value representing the color the pixel will be, e.g., representing different intensities of red, green and blue. The digital values are then passed to the digital signal processor which enhances the image, compresses it and then stores it in a digital file format in the storage module 110.

In other embodiments, the device 100 will further include an integrated scanning module 124 for scanning a symbology on an article of commerce. The scanning module 124 will contain a light source, e.g., LED, and photocell coupled to the computer processing module 120, or alternatively, will includes a separate decoder engine that will decode the data received by the photocell before sending it to the computer processing module 120. Knowledge of the art reveals that many different types of scanners currently exist and the inventor realizes that the type of scanner would depend upon the type of symbology that is utilized in the printed images. The symbology may be in any form currently practiced in the art including barcodes (e.g., UPC, EAN, PDF417, etc.), photosymbols, standard or specialized text, etc., or any future type of symbology.

It is to be appreciated that the capture module 122 may also be used in conjunction with the scanning module to read symbology associated with an article of commerce. Here, the capture module will acquire an image of the symbology and the scanning module will further include a digital signal processor executing an algorithm for deciphering or decoding the symbology from the capture image. The use of an image sensor to read symbology, e.g., a barcode, is known in the art.

The device 100 will also include an encryption module 126. The encryption module 126 will use conventional code encryption algorithms currently in use or that will be in use in the future such as symmetric-key algorithms, e.g., DES, Triple-DES, Blowfish, RC2, RC4, RC5, etc, and asymmetric-key algorithms, e.g., Diffie-Hellman, RSA, ElGamal, etc. to decrypt locked digital media content files that are stored in the storage module 110. The encryption module 126 may also encrypt payment information of a user before the payment information is transmitted to another device or server.

Furthermore, the device 100 will include a date and time module 128. The date and time module 128 will use standard computer chip processing technology widely in use, e.g., a crystal, or alternatively, input from a GPS receiver to supply the date and time.

In one embodiment, the device 100 according to the principles of the present disclosure is embodied as a mobile phone including the modules and architecture illustrated in FIG. 2. In this embodiment, microphone 106 is further coupled to a communication module 130 for encoding a user's speech to be transmitted via antenna ANT using CDMA, PCS, GSM or any other known wireless communication technology. The user will enter phone numbers to be dialed via the touch screen, or alternatively, as is known in the mobile phone art, the device 100 may include a full QWERTY keyboard as an input module to enter text information. In addition to producing audio from audio or multimedia content, speaker 116 will be coupled to the antenna ANT and a decoder for receiving and decoding voice communication from another mobile phone.

It is to be appreciated that the communication module 130 may include a single integrated circuit chip to perform data transfer and voice communications or a single module including a separate data transfer chip, e.g., a WiFi transceiver, and a separate voice communication chip, e.g., a CDMA chip. In one embodiment, the communication module will operate on the wireless GPRS (General Packet Radio Service) data protocol or a 3G protocol such as W-CDMA, CDMA2000 and TD-SCDMA. Both the GPRS and 3G protocols have the ability to carry both voice and data over the same service.

It is to be appreciated that the device 100 described above is an exemplary device and may include all or a portion of the modules described above. Furthermore, it is to be appreciated that existing mobile devices, e.g., mobile phones, digital media playback device, may be used in accordance with the principles of the system and method of the present disclosure described below.

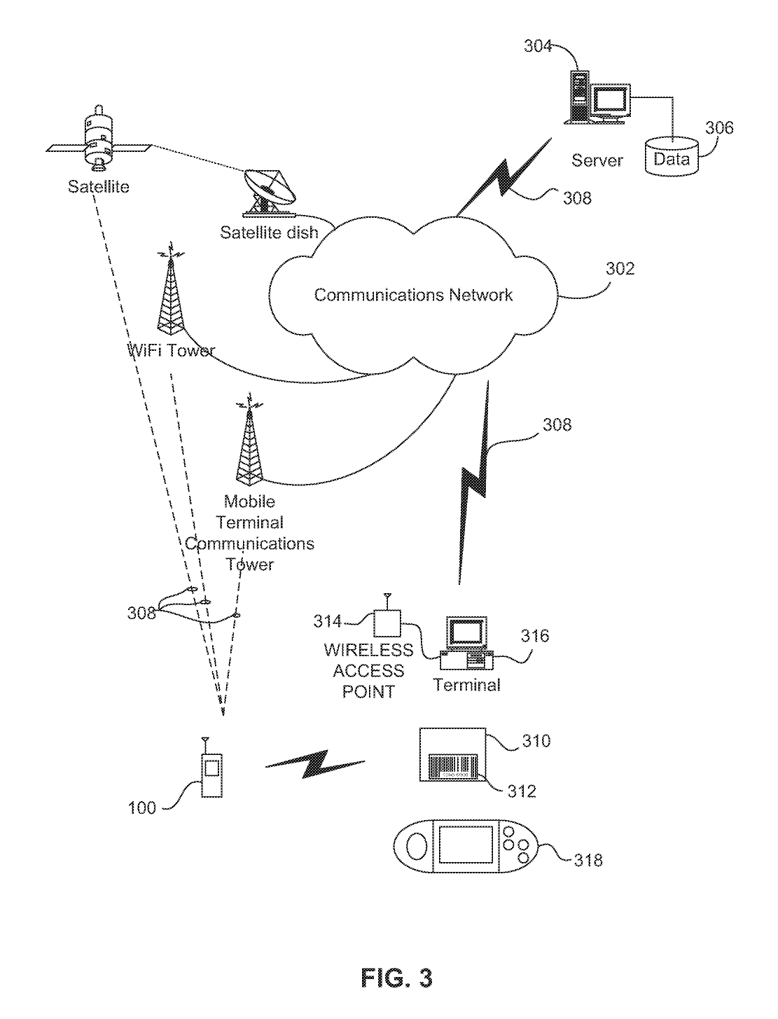

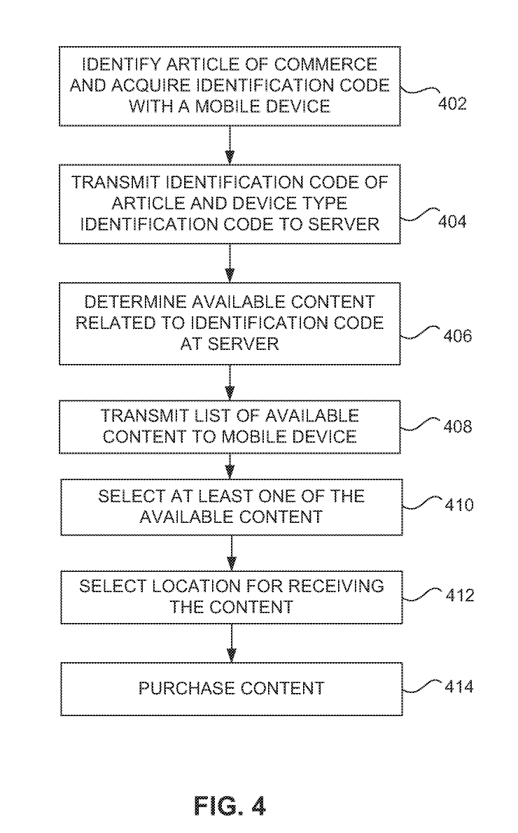

A system and method for identifying an article of commerce and delivering media content related to the article to a user over a network will be described in relation to FIGS. 3 and 4. Referring to FIG. 3, a system in accordance with the present disclosure is illustrated. The system includes a mobile device 100 as described above. The device 100 will communicate to a server 304 via a communication network 302. The device 100 and server 304 may be connected to the communications network 302, e.g., the Internet, by any known means, for example, a hardwired or wireless connection 308, such as dial-up, hardwired, cable, DSL, satellite, cellular, PCS, wireless transmission (e.g., 802.11a/b/g), etc. It is to be appreciated that the network 302 may be a local area network (LAN), wide area network (WAN), the Internet or any known network that couples a plurality of computers to enable various modes of communication via network messages. Furthermore, the server 304 will communicate using the various known protocols such as Transmission Control Protocol/ Internet Protocol (TCP/IP), File Transfer Protocol (FTP), Hypertext Transfer Protocol (HTTP), etc. and secure protocols such as Internet Protocol Security Protocol (IPSec), Point-to-Point Tunneling Protocol (PPTP), Secure Sockets Layer (SSL) Protocol, etc. The server 304 will further include a storage medium 306 for storing a database which links articles of commerce to various type of digital content, the details of which will be described in detail below.

Initially, in step 402, a user will identify an article of commerce and acquire an identification code from the article using a mobile device 100. The article of commerce could take many forms including but not limited to a book, a video or audio DVD, an audio CD, an electronic game, clothing item, retail item or household item, etc. As will be appreciated from the description below the identification code may take many forms such as a barcode number, a UPC number, an alphanumeric number assigned to the article of commerce, a name of the article, e.g., Batman Begins DVD, etc. The present disclosure may use any one or any combination of identification codes to determine if related content is available, for example, if a user identifies the article by name, the name will be used in a search engine to determine an associated alphanumeric code which will then be used to locate a record to determine if any related content is available for the identified article.

The process of identifying the articles of commerce can be used without an intent to actually purchase the available content. For example, as mentioned below with respect to virtual worlds, the user may wish to identify various articles of commerce for the purpose of adding a virtual likeness of the articles to the virtual world. In certain virtual worlds, the users may be given the ability to customize a space within the world. The present disclosure allows the user to retrieve information about an identified article of commerce and insert that article, or a likeness thereof, into his or her space as desired.

The user will utilize the portable digital device 100 to identify the article of commerce. For example, if the article of commerce 310 includes a barcode 312, the device 100 will scan the barcode 312 with the scanning module 124 and decode the barcode to acquire an identification code of the article. Alternatively, the device 100 will capture an image of the barcode using the capture module 122 and decode the barcode to acquire an identification code of the article. Furthermore, the user can also take a picture of the article of commerce via the capture module 122. Then using standard and existing computer processing power and software solutions such as Attrasoft Image recognition software, or optical character recognition software (OCR software such as OmniPage or ReadIris) the image or name of the article of commerce is decoded and the identity of the article of commerce is resolved.

With respect to capturing an image for the purpose of adding an object identified by the captured image into a virtual world, the user may utilize the capture module 122 to capture the image and also utilize visual search technology (VST) for identifying articles. Therefore, instead of identifying an object or product using a barcode or information input by a user, VST allows the user to search a database on a network to identify images on the network that have similar image qualities (e.g., shape, color, patterns, etc.) as the captured image. For example, if the user captures an image of a certain object (e.g., a sports car), the VST is able to find instances (e.g., webpages) on the network where similar images of the object are stored. In this way, the user can select the identified objects that exist on the network.

In another embodiment, the user will enter the identification code of the article via a user interface including input module 106. If the device contains a user interface allowing user keyboard input, the user will input the name of the article into the portable device. The user may also speak the name of the article of commerce into the portable device via the microphone 114 which in turn will process the spoken name into digital form via speech recognition software.

In a further embodiment, the articles of commerce will contain Radio Frequency Identification (RFID) tags. The portable digital device 100 will contain an RFID reader and the identity of the article of commerce will be resolved.

In another embodiment, the name or identification code of at least one article of commerce will be broadcast via a WiFi wireless access point 314 over a predetermined range. The device will receive this transmission via transmission module 112 and will present a listing of content to the user via the display module 104. The user may then select an article of interest. An example of this embodiment would be in a retail store, e.g., a movie rental store, where a list of new movie releases is continuously broadcast in the store via a wireless access point coupled to a server or terminal 316 in the store. This list would only be available when within the confines of the store. The device would present this list to the user and the user may select a movie of interest wherein the identification code for the movie, i.e., the article of commerce, would be identified via the terminal 316.

Furthermore, the name or identification code of an article of commerce may be broadcast from another mobile device, e.g., a gaming device 318. Here, a user approaches a second user having a gaming device 318 having at least one electronic game either stored in memory or currently being played. The gaming device 318 will broadcast the identification code of the at least one game, or alternatively, the second user may initiate the identification code being transferred, e.g., via an infrared port, to the first user.

Once the article of commerce is identified, the portable device 100 will use communications protocols including but not limited to WiFi (a, b, c d, n, x), mobile phone communications such as GSM, CDMA, FOMA, etc., infrared communications, cabled communications, Bluetooth communications, satellite communications, to transmit the identification code to a remote server on the global computer network (GCN), e.g., the Internet (step 404). It is to be appreciated the device 100 may use any one or a combination protocols to transmit the identification code to the server 304. For example, the device 100 may employ a telecommunication protocol to transmit the identification code via the communication module 140. In another embodiment, the device 100 may communicate to the server 304 via the same wireless access point 314 that broadcast the list of available content, e.g., a hot spot in a retail location.

In step 404, the device 100 will also transmit information identifying the user submitting the request. Furthermore, the device 100 will transmit a device type identification code to the server so the server may determine available content compatible with the device, e.g., ring tones for a mobile phone.

The server 304 may be maintained by a vendor associated with the article of commerce. For example, in the case of identifying a Warner Brothers™ DVD movie, the server may be a Warner Brothers server connected to a Warner Brothers website. However, the server may also be a vendor not associated or even competing with the article of commerce. For example, if the article of commerce is a Warner Brothers™ DVD movie, the server may be an e-commerce site such as Amazon.com that offers DVD movies from many companies including Warmer Brothers.

In step 406, the server 304 will then use standard computer processing power and standard database look up software (e.g., Microsoft™ Access or Oracles™ Database software) to see if it has information on the article of commerce in its database 306. Such information will include but not be limited to what the article of commerce contains (including chapters, episodes, songs, ring tones, etc.), and whether full or partial digital content is available for download for the identified article of commerce and, if available, the location of the content. In one embodiment, the server will select available content based on the device type identification code. For example, if the device type identification code indicates a mobile phone, the server will determine if ring tones are available. If the device type identification code indicates a mp3 player, the server will determine if audio content is available. Further, the server will also identify the user requesting the information on the article of commerce and what the user's preferences and device locations are for downloading the selected content, as well as any existing e-commerce information on the requested user such as stored credit card and address information.

The server 304 will then use standard communications protocols described above to transmit or download the determined information, e.g., a list of available content, back to the portable digital device (step 408). This information will appear on the display of the portable digital device, although in another embodiment, this information may also be given to the user by audio via speaker 116 by utilizing a text-to-speech software program. The user will now be informed, i.e., by the server, what content or parts of content for the selected article of commerce is available for download e.g., either to purchase or preview. The user will also be informed of the price of this download. Optionally, the user will be informed where the download will be sent to using the information the user has previously supplied the server, e.g., a home computer of the user which is coupled to the network 302.

If the user wants to purchase any of the available content or if the content is available for free, the user will now use the user interface of the portable digital device including but not limited to character input, or voice input to enter his selection and make the purchase (step 410). Optionally, the user may also select a location for receiving the content other than the mobile device 100, e.g., a computer, a second mobile device, etc. (step 412). This information, e.g., location information, credit card information, etc., will be inputted into the portable digital device via the user interface and will then be transmitted to the server. The server will use standard computer processing power and e-commerce software to approve the transaction (step 414). Once (and if) the transaction is approved, the server will transmit the digital content to the address that the user has provided, e.g., the mobile device, a mobile phone, a local personal computer, etc. In another embodiment, the server 304 may not have stored the digital content, but it may cause another site or server on the global computer network where the subject digital content is stored, to transmit the content to the user at the address provided.

In another embodiment, the user will select the desired content and download the content to preview the content before conducting a purchase transaction. The preview of the content may be a portion of the content that will be downloaded to the device specified by the user. The preview may include digital images of the article of commerce. After previewing the device, the user may purchase the complete content via a standard e-commerce transaction. Alternatively, the complete content will be transmitted to the user for preview. In this embodiment, the content may be enabled for a predetermined period time so the user can preview the content where when the predetermined period of time expires, the user will either purchase the content or the content will be disabled. Alternatively, a portion of the complete content may be enabled to be viewed by a user where the user will purchase a key for example to enable the complete content selection.

Once the content is transmitted to the portable digital device (or in some cases to the user's home computer), the content will be stored in the memory of the device. The user may call this content from memory at any time and using standard computer processing power and software application programs such as Apple's™ iTunes, Microsoft's™ Media Player, text reader programs, music ring tone playback programs, etc., the content can be utilized.

In another embodiment of the present disclosure, the user may use one device to identify the article of commerce, and to transmit the identification code of the article to the remote server. This same device will also be used to implement the e-commerce transaction that allows the user to purchase the selected content or obtain the selected content for free. However, in this embodiment, the server, or affiliated servers, will transmit the selected content to a second device, e.g., another portable digital device for use by the user, a home personal computer, a personal computer of a friend, etc.

In another embodiment, after the user has selected at least one of the available content (step 410), the selection will be transmitted to the server and the server will retrieve a purchase price or transaction amount from a plurality of different vendors or distributors of the at least one content. The information from the plurality of vendors will be compiled into a list to be transferred to the device. At the device, the list will be presented to the user so the user may conduct comparison shopping of the at least one available content at a point of purchase, e.g., a retail location.

In utilizing the principles of the present disclosure, a user will be able to accomplish the various applications described below where content is identified and delivered to a device:

### Music Content to Ring Tones

Conventional mobile telephones allow a user to select custom ring tones to allow the user to hear a ring tone of their choice. The user must scroll through a selection choice provided by the service carrier and then downloads the digital ring tone files to their telephone. The selection choice is limited and cumbersome to the user, in that, the user has to scroll through many menus to finally select his/her hopeful choice.

With the present disclosure, the user would be able to walk into any retail establishment, or in fact into any location (including a friends home, etc), that has digital content. The user would then have the mobile phone identify the selected media content (e.g., a music CD), transmit the identification code of the content to a remote server and the server would tell the user if any ring tones are available for the selected content. If ring tones are available, the user could purchase the selected ring tone or ring tones, and the user would then download this tone into his mobile phone. This whole transaction could take place in several minutes time as opposed to the current system of endlessly looking through menus and submenus for the ring tone that the supplier offers.

Games to Portable Game Player Devices

Using the system and method described herein the user would be able to walk into any retail establishment or, in fact, into any location (including a friend's home etc.) that has digital content, e.g., a game. The user would then use the user interface on the applicable digital device such as the Sony™ PSP to identify the selected media content, e.g., enter a name of the game, pickup the identification code wirelessly via its WiFi capability via a broadcast access point or directly from another gaming device, etc. The device will then transmit the identification code of the content to a remote server and the server would inform the user if the game content of the selected game is available for the selected content. If the content is available, the user could purchase the selected game, and the user would then download this game into his digital device. This whole transaction could take place in several minutes time. If the selected article of commerce contained multiple games, the user could select just one or more of the games as opposed to the whole content.

In another embodiment of the present disclosure, the user could use one portable digital device, such as a mobile phone (perhaps with an integrated CCD device) to identify the article of commerce, use this same device to purchase the selected digital content, and then direct the digital content to be downloaded on another portable media device, e.g., a gaming device, or even to have the content downloaded on the user's desktop computer.

Text to Portable Digital Text Reader

Using the system and method described herein, the user would be able to walk into any location that has digital content in this case text content (such as a book or a magazine.) The user would then use the user interface on the applicable digital device such as the HP Windows CE Ipaq H6325 (which includes an integrated camera and a cellular phone) to identify the selected media content, transmit the identification code of the content to a remote server and the server will inform the user if content of the book or magazine is available. If the content is available, the user could purchase the selected content, and the user would then download this content into this digital device. This whole transaction could take place in several minutes time. If the selected article of commerce contained articles, chapters, etc. of the selected printed material, the user could select just one or more of the articles, chapters, etc. as opposed to the whole content.

In another embodiment of the present disclosure, the user could use one portable digital device, such as a mobile phone (perhaps with an integrated CCD device) to identify the article of commerce, and then use this same device to purchase the selected digital content, and then direct the digital content to be downloaded on another portable media device, or even to have the content downloaded on the user's desktop computer. Of course, once the content is downloaded the user can utilize the content by employing any number of text reader applications specific to the digital device that the user has downloaded the content to.

### Audio or Video Content to Portable Digital Player

Using the system and method described herein, the user would be able to walk into any retail location (or any other location) that has digital audio or video content such as a music DVD, music CD, audio book or a DVD of a film or television show, etc. The user would then use the user interface on the applicable digital device such as the Archos PMA430 from Archos of Irvine, Calif. (which includes integrated WiFi) to identify the selected media content e.g., enter a name of the content, pickup the identification code wirelessly via its WiFi capability via a broadcast access point or directly from another media playing device, etc., The device will then transmit the identification code of the content to a remote server, and the server would inform the user if the content of the music or film DVD is available. If the content is available, the user could purchase the selected content, and the user would then download this content into this digital device. This whole transaction could take place in several minutes time. If the selected article of commerce contained multiple songs as is the case with a music CD/DVD or episodes as is the case with many television/movies DVDs, the user could select just one or more of these songs or episodes as opposed to the entire content.

In another embodiment of this invention, the user could use one portable digital device, such as a mobile phone (perhaps with an integrated CCD device) to identify the article of commerce, and then use this same device to purchase the selected digital content, and then direct the digital content to be downloaded on another portable media device, or even to have the content downloaded on the user's desktop computer. Of course, once the content is downloaded the user can play the content by using any number of media player software applications such as iTunes from Apple Computers, Inc. of Cupertino, Calif. or Microsoft Media Player from Microsoft of Redmond, Wash.

Likeness of Image into a Virtual Environment

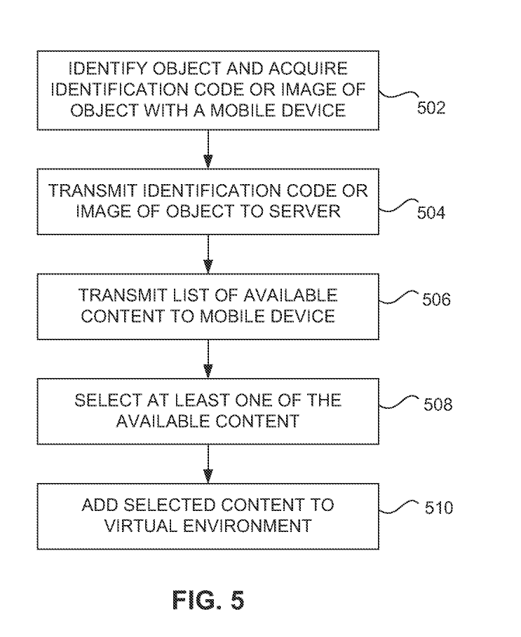

FIG. 5 is a flow diagram illustrating an embodiment of a method for adding the likeness of an object from the real world into a virtual world. In step 502, a user identifies an object and acquires an identification code, if one exists, or image of the object using the mobile device 100. The identification code may include a barcode, UPC code, or other code used to identify the object. In some cases, if a code for the object is not received or not available, the user may utilize the capture module 122 to obtain an image of the object. Then, using VST, the image may be processed to determine the object's identity.

After identifying the object, the method further comprises transmitting the identification or image of the object to a remote server, as indicated in block 504. The server receives the identification or image of the object and may be configured to response with a number of choices that are available to the user. The choices may include whether to purchase content including if the purchase price is for a zero amount, and/or whether to incorporate an image showing an appearance of an object into the virtual world. In step 506, the method includes transmitting a list of available content and/or images from the server to the mobile device, where the mobile device displays the list of available content to the use. The available content is not necessarily content that may be purchased, but may include information about the appearance, such as size, colors, dimensions, etc., of the object. In one embodiment, an image of how the object will appear in the virtual world, i.e., a virtual representation of the object, is displayed on the display device of the user.

In response, the user is enabled to select at least one of the available content, as indicated in block 508. The server may also offer a number of different views of the object that is to be placed in the virtual world. In this way, the visual representation of the object (based on an avatar's location within the virtual world and direction of view of the avatar within the virtual world) may be changed accordingly. Also, information about the dimensions of the object may be available from the server to allow proper perspective of the object within the virtual world.

The user then selects the desired content to be added to a virtual world, as indicated in block 510. The selection of content may further include the process of selecting one or more virtual worlds into which the content is placed. In some embodiments, the adding of content into a virtual world may include a virtual purchase using a monetary or credit system used in that virtual environment and/or a real purchase using real money. With the selection and/or purchase of the object or likeness of the object, the user is able to add or enhance his or her space within the virtual world according to his or her wishes. In one embodiment, the cost of the article of commerce or object added to the user's virtual world will be determined by the server hosting the virtual world when the object is identified as above. In another embodiment, the cost of the article of commerce or object is the retail price of the object in the real world. In this embodiment, the mobile device or server will access either a database or search engine to determine the current retail price of the article in the real world.

Adding the likeness of objects from the real world into a virtual world may be accomplished using various processes. According to one embodiment, the user may utilize the mobile device to identify and download an appearance or rendering of the object. From the mobile device, the rendering may be transmitted to a personal computer, laptop computer, another mobile device, or other processing device that is associated with the user. From the second processing device, which would be connected to a network on which the virtual world can be accessed, the object's rendering may be uploaded to the virtual world. According to another embodiment, the rendering may be uploaded from the mobile device directly to the virtual environment and can be accessed later by an associated processing device. According to another embodiment, the mobile device may include an application that supplies identified objects to the virtual world or allows a user to upload the likeness of the object to the virtual world and also access the virtual world via the network.

The system and method of the present disclosure will provide a user with not only instant delivery and accessibility, but a seamless way of obtaining content (as opposed to manually loading the content), and in many cases, a better economic model to obtain the content. The latter statement is supported because the present disclosure allows the user to compare the price of the content at the source (for example, a retail store) versus the price to instantly receive the content from an Internet source or sources. Further, the user may custom select the content that he desires and, instead of obtaining all content, he may decide to purchase less of the content (i.e., a portion or subset of the content) therefore customizing his selection, and reducing his/her price for the content. For uses with virtual environment, the selected content may be placed within one or more virtual worlds accessible to the user.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method of adding content to a virtual environment, the virtual environment being a computer-based simulated environment hosting by at least one server coupled to the Internet, the method comprising the steps of:
identifying a specific object in the real world and obtaining an identification of the specific object using a mobile device;
displaying on a display of the mobile device a list of available content related to the specific object; and
selecting at least one available content from the list of available content and adding the selected content to the virtual environment.

2. The method as in claim 1, wherein the virtual environment is a virtual world accessible to a plurality of users.

3. The method as in claim 1, further comprising using a monetary system in the virtual environment to purchase the selected content.

4. The method as in claim 1, further comprising using a monetary system in the real world to purchase the selected content.

5. The method as in claim 1, wherein obtaining the identification of the object includes capturing an image of the object.

6. The method as in claim 5, wherein determining the list of available content further comprises utilizing visual search technology (VST) to obtain a list of available content.

7. The method as in claim 1, wherein adding the selected content comprises adding a likeness of the specific object to the virtual environment.

8. The method as in claim 1, wherein the list of available content comprises information related to the size, colors, and dimensions of the specific object.

9. The method as in claim 8, further comprising rendering the specific object in the virtual environment using the dimensions of the specific object.

10. The method as in claim 9, wherein rendering the specific object in the virtual environment further comprises calculating a perspective view of the specific object based on a location and direction of view of an avatar in the virtual environment.

11. The method as in claim 1, wherein adding the selected content further comprises adding the selected content to a plurality of virtual environments.

12. The method as in claim 1, wherein selecting the at least one available content further comprises transmitting the selected content to a second processing device from which the virtual environment may be accessed.

13. The method as in claim 1, further comprising:
transmitting the identification of the specific object from the mobile device to a server on a network; and
determining, by the server, the list of available content related to the specific object and transmitting the list to the mobile device.

14. A system for adding content to a virtual environment, the system comprising:
a mobile device configured to identify a specific object in the real world and obtain an identification of the specific object; and
a server in communication with the mobile device via a network;
wherein the mobile device is further configured to transmit the identification of the specific object to the server;
wherein the server is configured to determine a list of available content related to the specific object and transmit the list to the mobile device; and
wherein the mobile device is further configured to enable a user to select at least one available content from the list of available content and add a likeness of the selected content to a virtual environment that is accessible via the network.

15. The system as in claim 14, wherein the virtual environment is a virtual world accessible to a plurality of users.

16. The system as in claim 14, wherein the mobile device comprises an image capture device configured to obtain the identification of the object.

17. The system as in claim 14, wherein the server utilizes visual search technology (VST) to determine the list of available content.

18. The system as in claim 14, wherein the server is further configured to store information related to the size, colors, and dimensions of a plurality of objects.

19. The system as in claim 18, further comprising a server, associated with the virtual environment, configured to render the specific object in the virtual environment using the dimensions of the specific object.

20. The system as in claim 19, wherein the server associated with the virtual environment is further configured to render the specific object in the virtual environment by calculating a perspective view of the specific object based on a location and direction of view of an avatar in the virtual environment.
